(19) United States
(12) Patent Application Publication
(10) Pub. No.: US 2026/0115956 A1
(43) Pub. Date: Apr. 30, 2026

(54) FOOD PROCESSING MACHINE ADAPTED FOR CHOPPED CUTS

(71) Applicant: Sammic, S.L., Azkoitia (ES)

(72) Inventors: Gorka Agierrezabal Oteiza, Azkoitia (ES); Aitor Agierrezabalaga Zubizarreta, Azkoitia (ES)

(21) Appl. No.: 19/361,148

(22) Filed: Oct. 17, 2025

(30) Foreign Application Priority Data
Oct. 30, 2024 (ES) 202432008

(51) Int. Cl. B26D 3/22; B26D 1/29; B26D 7/06

(52) U.S. Cl. CPC B26D 3/22; B26D 1/29; B26D 7/0641; B26D 2210/02

(57) ABSTRACT

A food processing machine adapted for diced cuts includes a feed chute and a strip-cutting disc. The feed chute is configured to receive and direct a food substrate for processing. The strip-cutting disc is operatively connected to a connection shaft configured to transmit rotation from a motor. The strip-cutting disc comprises at least one H-blade configured to make a cut perpendicular to a direction of the feed chute, and a plurality of V-blades, wherein the V-blades are configured to make a cut in a direction of rotation of the strip-cutting disc. The strip-cutting disc further comprises an output ramp for discharging the processed food, characterized in that the output ramp comprises an additional unitary cutting accessory configured in cutting sectors, connected to the connection shaft and following the strip-cutting disc, and configured to make a cut substantially parallel to the connection shaft in at least portions thereof.

### CROSS-REFERENCE TO RELATED APPLICATION

This is a U.S. utility patent application claiming priority under the Paris Convention to the Spanish Utility Model ES U 202432008, filed on Oct. 30, 2024, the contents of which are hereby incorporated by reference in their entirety.

### FIELD

This disclosure is directed to a food processing machine adapted for chopped cuts, of types used in fine cuisine preparation and in the hospitality industry to cut foods such as onion, tomato, or potato, adapted to make cuts in special measured strips used in hospitality, such as, among others, a julienne cut of nominally 0.5×0.5×4 cubic centimeters (cm³), a paysanne cut of nominally 0.5×0.5×2 cm³, a dice or mirepoix cut of nominally 1×1×1 cm³, or even a brunoise cut of nominally 0.5×0.5×0.5 cm³.

### BACKGROUND

Currently, and as a reference to the state of the art, food processors equipped with cutting assemblies are known, which slice food through the action of a cutting disc equipped with a blade that makes a cut perpendicular to the food, with the thickness of the slice depending on the distance between the disc and the blade. Also known are food processors equipped with cutting assemblies that cut food into strips through the action of a cutting disc equipped with a blade that makes a perpendicular cut.

Processors equipped with cutting assemblies are also known, where, through the combined action of a cutting disc equipped with a blade that makes a first perpendicular cut to the food in the form of a slice, and a disc placed immediately afterward with several blades arranged in a grid or crisscrossed pattern—through which the pre-sliced food is forced—a dice, cube, or chopped cut of the food is achieved.

This configuration works well for most foods if the aim is to cut the food into relatively large dimensions. However, for relatively small dimensions—such as brunoise or mirepoix cuts—and especially with soft foods like tomato or cooked products like boiled egg, forcing the slice of food through the grid causes the food to lose its desired shape and become a puree. In hard foods like potatoes, machines with more power are required, since forcing a hard food through such a small opening entails high effort.

Another problem with this disc and grid configuration is that in the manufacture of the cutting grid, the blade joints are made through insertions and recesses, which create small spaces where food accumulates, making cleaning very difficult. This requires special attention and a great deal of time to clean the accessories to prevent cases of food contamination from deteriorated food residues left in the recesses and not properly removed.

### SUMMARY

In light of the above, the present disclosure relates to a food processing machine adapted for chopped cuts, which includes a feed chute designed to receive and guide whole or halved or other initially chopped food, forming a food substrate for processing. Inside the food processing machine, there is a strip-cutting disc, operatively connected to a drive shaft configured to transmit rotation from a motor to the strip-cutting disc. The strip-cutting disc comprises at least one H-blade configured to make a cut perpendicular to the direction of the feed chute, generating food slices, and a plurality of generally parallel V-blades, substantially perpendicular to the at least one H-blade, configured to make cuts in the rotational direction of the strip-cutting disc and generate food strips. The food processing machine includes an output ramp for extracting the processed food. The food processing machine may comprise an additional unitary cutting accessory, configured in cutting sectors, connected and immediately following the strip-cutting disc, configured to make a cut parallel to the drive shaft and to cut the previously obtained food strips into the desired dimension.

Thus, a food processing machine adapted for diced cuts includes a feed chute and a strip-cutting disc. The feed chute is configured to receive and direct a food substrate for processing. The strip-cutting disc is operatively connected to a connection shaft configured to transmit rotation from a motor. The strip-cutting disc comprises at least one H-blade configured to make a cut perpendicular to a direction of the feed chute, and a plurality of V-blades, wherein the V-blades are configured to make a cut in a direction of rotation of the strip-cutting disc. The strip-cutting disc further comprises an output ramp for discharging the processed food, characterized in that the output ramp comprises an additional unitary cutting accessory configured in cutting sectors, connected to the connection shaft and following the strip-cutting disc, and configured to make a cut substantially parallel to the connection shaft in at least portions thereof.

“Posterior” or “following” are herein understood to mean, following the phases of food processing in this food processing machine, the elements that process the food in a phase subsequent to another, with the food sequentially passing through the following processing phases: feed chute in the input phase; strip-cutting disc in the strip-cutting phase; additional unitary cutting accessory in the chopping phase, in embodiments that include an additional unitary cutting accessory; a guide disc in the food collection phase; and an output ramp in the food output phase.

“Immediately posterior” is herein understood to mean, following the described food processing phases, the element that receives the food substrate in the next subsequent phase.

For food introduced through the feed chute of this type of food processor, the strip-cutting disc (or julienne disc) first processes the food, which makes cuts in the food as it rotates due to the drive shaft powered by the motor to which the strip-cutting disc is rotationally connected. The disc rotation is driven by the connection protrusions on the drive shaft against the interior of the L-shaped recess located in the disc's central ring, generating food strips. The food strip is generated in the cutting direction of the strip-cutting disc. Once cut, the strips are deposited concentrically on the additional unitary cutting accessory and are moved by the geometry of the strip-cutting disc against the cutting sector blades of the additional unitary cutting accessory, which makes a cut in the direction of the drive shaft (perpendicular to the food strip).

Thanks to this configuration of the additional unitary cutting accessory with blades arranged in cutting sectors, on the one hand, the food strips are cut to the desired size, as each cutting sector contains properly positioned blades adapted to be generally perpendicular to the strips, and on the other hand, it facilitates cleaning of the cutting accessory by not requiring interlocked blades to optimize cutting, thus avoiding small recesses between blades that tend to accumulate food residue.

Another feature of the present disclosure is that the additional unitary cutting accessory may be configured in at least two cutting sectors arranged in a radial distribution, consisting of blades oriented in different directions.

The deposition of strips on the surface of the additional unitary cutting accessory does not occur only in the area immediately following the feed chute, but due to the high processing speeds, the strip-cutting disc itself can drag the strips deposited on the surface of the additional unitary cutting accessory, changing the angular position of the strips. A uniform arrangement of blades across the entire disc area cannot address the change in angular position of the food strip, resulting in unevenly cut food. Thanks to the configuration of the additional unitary cutting accessory arranged in multiple cutting sectors distributed radially, it is possible to cut food strips to the desired size, addressing the change in angular position of the food strip, since the cutting sector blades may be advantageously oriented at all angular positions of the disc.

Another particular feature of the present disclosure is that the additional unitary cutting accessory may include an additional blade at a junction between cutting sectors.

In ways such as these, in addition to having a suitable cutting sector at all angular positions of the disc, irregular cuts that may be generated at the transitions between cutting sectors are avoided, thus obtaining a uniform final cut of the processed food, and preventing damage from crushing of more delicate food.

Optionally, the cutting sectors of the additional unitary cutting accessory may be delimited by the bending of the cutting sector blades.

With this configuration, in addition to achieving the delimitation of the sectors composed of similarly oriented cutting sector blades, the number of joining elements holding the cutting sector blades in place may be reduced, facilitating the cleaning of the additional unitary cutting accessory.

Optionally, the food processing machine may comprise a guide disc connected to the connection shaft, which rotates due to the action of the thrust wall of the connection shaft against at least one smooth wall forming the central guide ring of the guide disc and immediately following the additional unitary cutting accessory. The guide disc may comprise at least one guide fin capable of collecting the processed food and guiding the processed food to the output ramp.

Thanks in part to this guide disc, soft foods such as tomatoes can be gently collected and directed immediately to the output ramp, thus preventing the newly processed food from falling onto previously processed food and becoming damaged by the impact.

The additional unitary cutting accessory may comprise at least one lug capable of fitting into at least one corresponding engagement recess in the food processing machine. Thanks to this fitting, the additional unitary cutting accessory may remain static, ensuring that the cutting accessory is not dragged by the rotation of the strip-cutting disc. This allows the strips of food to be forced by the geometry of the strip-cutting disc in its rotational movement.

### BRIEF DESCRIPTION OF DRAWINGS

In order to better understand the nature of this disclosure, the attached drawings represent an example industrial embodiment, which is merely illustrative and non-limiting.

FIG. 1 shows a perspective view of the food processing machine (1), and in operational insertion order from closest to farthest from the food processing machine (1), the guide disc (4), the additional unitary cutting accessory (3), and the strip-cutting disc (2). In the food processing machine (1), with the lid open, the end of the feed chute (1c), the food output ramp (1b), two engagement recesses (1d) and the installed connection shaft (1a) are visible, showing from closest to farthest from the food processing machine (1), the thrust wall (1a.3), the smooth shaft (1a.2), and the joining protrusion (1a.1). In the guide disc (4), the central guide ring (4a) composed of two smooth walls and two guide fins (4b) is shown. In the additional unitary cutting accessory (3), two lugs (3b) matching in shape and number with the engagement recesses (1d), the central accessory ring (3a) and four cutting sectors (3c) composed of a plurality of cutting sector blades (3c.1) are shown. In the strip-cutting disc (2), the central disc ring (2a) and two sets each formed by an H-blade (2b) and a plurality of V-blades (2c) are shown.

FIG. 2A shows a perspective view of the strip-cutting disc (2), showing the central disc ring (2a) and two sets each formed by an H-blade (2b) and a plurality of V-blades (2c). FIG. 2B shows a perspective view of the rear of the strip-cutting disc (2), showing the L-shaped recess (2a.1) in the central disc ring (2a) and the geometry of the strip-cutting disc (2), which facilitates the pushing of food. FIG. 2C shows a perspective view of the connection shaft (1a), showing the rotational connection (1a.4), which operates in connection with the motor of the food processing machine (1), the thrust wall (1a.3), which operates in connection with the smooth wall forming the central guide ring (4a), the smooth shaft (1a.2), and the joining protrusion (1a.1), which operates inserted into the L-shaped recess (2a.1).

FIG. 3A shows a perspective view of one execution of the additional unitary cutting accessory (3), showing two lugs (3b), the central accessory ring (3a) and four cutting sectors (3c) composed of a plurality of cutting sector blades (3c.1). FIG. 3B shows a perspective view of another execution of the additional unitary cutting accessory (3), showing two lugs (3b), the central accessory ring (3a), four cutting sectors (3c) composed of a plurality of cutting sector blades (3c.1), and additional blades (3d) arranged at the intersections of the sectors. FIG. 3C shows a perspective view of another execution of the additional unitary cutting accessory (3), showing two lugs (3b), the central accessory ring (3a) and four cutting sectors (3c) delimited by the curvature of the cutting sector blades (3c.1).

FIG. 4 shows a cross-section of the food processing machine (1) with the guide disc (4), the additional unitary cutting accessory (3) and the strip-cutting disc (2) in operational position, displaying the operational direction of the food substrate from its insertion through the feed chute (1c) to its exit via the output ramp (1b).

The following references are indicated in these figures:
1. Food processing machine
   1a. Connection shaft
      1a.1. Joining protrusion
      1a.2. Smooth shaft
      1a.3. Thrust wall
      1a.4. Rotational connection
   1b. Output ramp
   1c. Feed chute
   1d. Engagement recess
2. Strip-cutting disc
   2a. Central disc ring
      2a.1. L-shaped recess
   2b. H-blade
   2c. V-blade
3. Additional unitary cutting accessory
   3a. Central accessory ring
   3b. Lug
   3c. Cutting sector
      3c.1. Cutting sector blades
   3d. Additional blade
4. Guide disc
   4a. Central guide ring
   4b. Guide fin

### DETAILED DESCRIPTION OF ILLUSTRATIVE EXAMPLES

With reference to the drawings and references listed above, the attached diagrams illustrate an example embodiment of the object of the present disclosure, referring to a food processing machine (1) adapted for chopped cuts that comprises a feed chute (1c) configured to receive and direct the food substrate for processing, a strip-cutting disc (2), in operative connection with a connection shaft (1a) configured to transmit rotation from a motor. The strip-cutting disc may comprise at least one H-blade (2b) configured to make a cut perpendicular to the direction of the feed chute (1c), and a plurality of V-blades (2c), which may illustratively be generally parallel, substantially perpendicular to the at least one H-blade (2b) and configured to make a cut in the direction of rotation of the strip-cutting disc (2). The food processing machine (1) may further comprise an outlet ramp (1b) to extract the processed food. The food processing machine (1) may comprise an additional unitary cutting accessory (3) immediately after the strip-cutting disc (2), which may comprise cutting sector blades (3c.1), configured to make a cut in the direction of food processing, and arranged in sectors relative to the additional unitary cutting accessory (3).

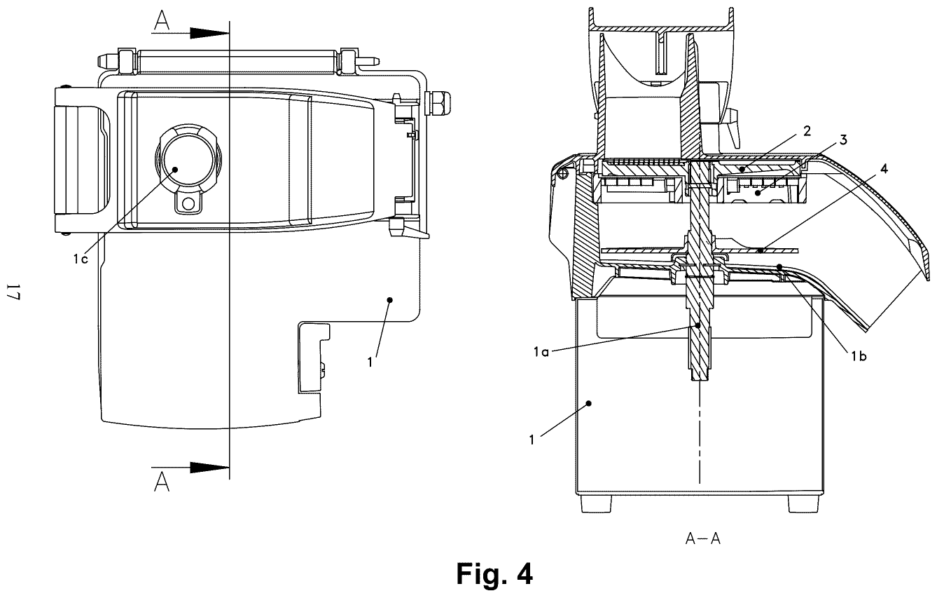

With reference to the figures, the food substrate, which may comprise a whole food item or one that is pre-peeled and/or pre-cut into smaller pieces, may be introduced into the food processing machine (1) through the feed chute (1c) (see FIG. 4) located in the lid of the food processing machine (1), understood as the initial phase taking place at the front of the machine. The introduction of the food substrate into the feed chute (1c) can be aided by a plunger, pusher, or other element, which may also be beneficial for safety reasons. The feed chute (1c) may comprise a protrusion of adequate length to keep an operator's hand away from the cutting elements and may be generally circular in section, although it may be adapted depending on the type of food for which it is mainly intended.

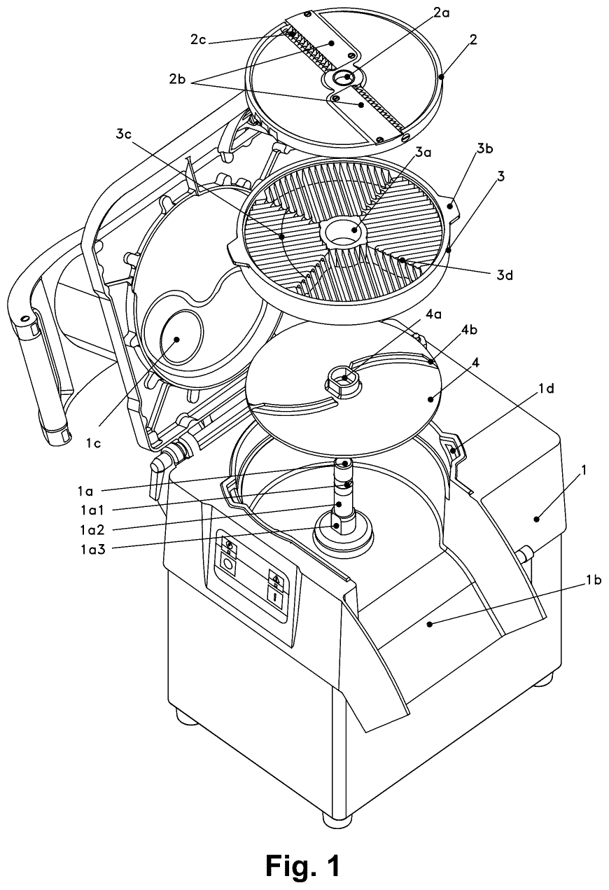

The food substrate is then directed towards the strip-cutting disc (2) (see FIG. 1), which cuts the food as it rotates. The feed chute (1c) may be manufactured in various dimensions and shapes, and the same machine may have more than one feed chute (1c) of different dimensions and/or shapes.

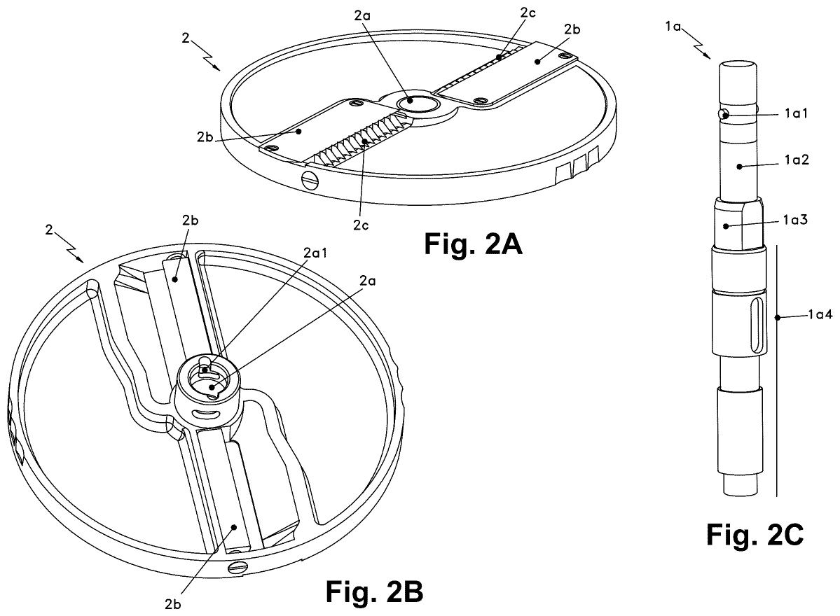

The rotation of the strip-cutting disc (2) may be driven by the action of the connection shaft (1a), which may be powered by a motor (not shown) of the food processing machine (1) to which it is joined at its rotational connection (1a.4). The operative connection between the cutting disc (2) and the connection shaft (1a) may be established by inserting the joining protrusions (1a.1) of the connection shaft (1a) into the L-shaped recesses (2a.1) located on the central disc ring (2a) (see FIG. 2B). The configuration of the L-shaped recesses (2a.1) may allow quick insertion and removal of the strip-cutting disc (2) for replacement or cleaning, while in operation, since the joining protrusions (1a.1) of the connection shaft (1a) may exert force against the interior (bottom end of the L) in the L-shaped recesses (2a.1), accidental extraction of the strip-cutting disc (2) may be prevented while simultaneously transmitting rotation.

The strip-cutting disc (2) may make cuts to the food substrate in substantially perpendicular directions, forming food strips. The strip-cutting disc (2) may first make a plurality of cuts in the direction of the disc's rotation via the plurality of V-blades (2c), and almost simultaneously a cut perpendicular to the direction of the feed chute (1c) via the at least one H-blade (2b), thereby producing food strips. These food strips, thanks to the geometry of the strip-cutting disc (2), change direction and are deposited concentrically on the surface of the additional unitary cutting accessory (3).

The food strips deposited concentrically on the surface of the additional unitary cutting accessory (3) may be directed by the geometry of the strip-cutting disc (2) against the cutting sector blades (3c.1), arranged in cutting sectors (3c) of the additional unitary cutting accessory (3), located immediately after the strip-cutting disc (2), which may make a cut in the direction of the connection shaft (1a) (which may be substantially perpendicular to the strip of food), which may delimit the length of the strip.

Each cutting sector (3c) may comprise a plurality of cutting sector blades (3c.1). The cutting sector blades (3c.1) of adjacent cutting sectors (3c) may be oriented in different directions.

The additional unitary cutting accessory (3) may remain static, while the strip-cutting disc (2) may rotate over it. To ensure the immobility of the additional unitary cutting accessory (3), the connection shaft (1a) may pass without contact through the central accessory ring (3a) in the smooth shaft area (1a.2), allowing the connection shaft (1a) to rotate without transmitting movement. Furthermore, the insertion of the lugs (3b) of the additional unitary cutting accessory (3) into the corresponding engagement recesses (1d) of the food processing machine (1) may ensure the correct angular positioning of the additional unitary cutting accessory (3) and may prevent the additional unitary cutting accessory from being dragged by the rotation of the strip-cutting disc (2). By remaining static, the additional unitary cutting accessory (3) may allow the food strips to be guided by the geometry of the rotating strip-cutting disc (2). Immobility may be ensured by any type of removable connection, or fitting or locking mechanism such as pins, bayonet fittings, etc.

Thanks to this configuration of the additional unitary cutting accessory (3), with cutting sector blades (3c.1) arranged in sectors, it is possible, on the one hand, to cut the food strips to the desired size by placing the cutting sector blades (3c.1) properly in each sector, adapted to the concentric position of the food strips; and on the other hand, to facilitate cleaning of the additional unitary cutting accessory (3), as each sector is made up of cutting sector blades (3c.1), eliminating the need for small recesses that usually appear at the intersections of two blades and which tend to accumulate food residue.

The additional unitary cutting accessory (3) may be configured into a plurality of cutting sectors (3c) comprising cutting sector blades (3c.1), which may arranged in a radial distribution, in some examples.

The strip-cutting disc (2) does not deposit food strips only on the area of the additional unitary cutting accessory (3) located immediately behind the feed chute (1c), since, due to the high processing speeds, the strip-cutting disc (2) may drag the strips deposited on the surface of the additional unitary cutting accessory (3), changing the angular position of the food strips. A uniform arrangement of blades over the entire area of the cutting disc (3) would not be able to resolve this change in the angular position of the food strips, resulting in unevenly cut food. Thanks to the configuration of the additional unitary cutting accessory (3), with cutting sectors (3c) arranged in a radial distribution, the desired size of the food strips may be achieved by compensating for any angular shift of the food strip, since a cutting sector (3c), composed of appropriately oriented cutting sector blades (3c.1), may be available at substantially every angular position of the disc.

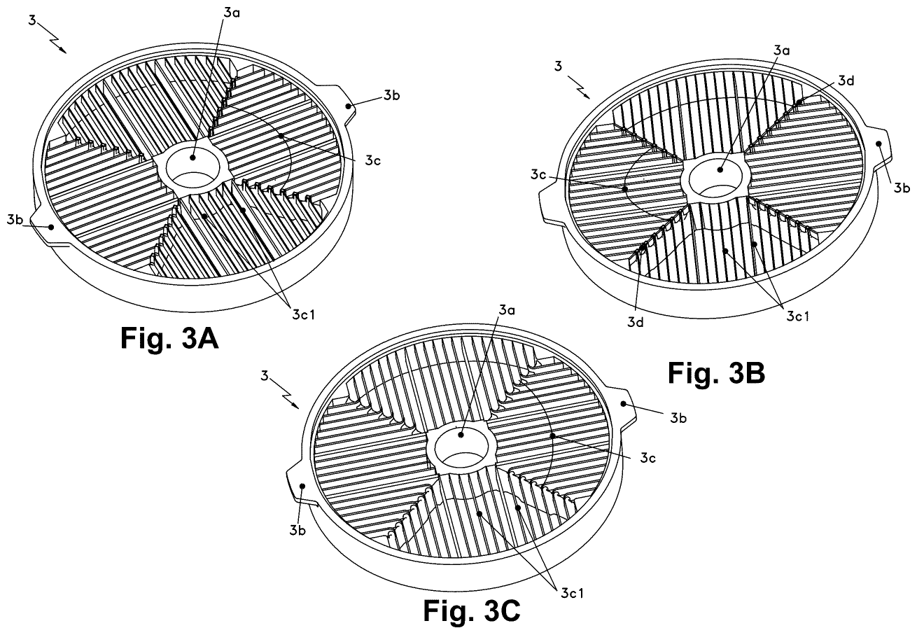

Another feature of the present disclosure is that the additional unitary cutting accessory (3) may include an additional blade (3d) at the junction between cutting sectors (3c) (see FIG. 3B).

In ways such as these, in addition to having a cutting sector (3c) with cutting sector blades (3c.1) appropriately oriented at all angular positions of the additional unitary cutting accessory (3), irregular cuts that can occur at the transitions between cutting sectors (3c) may be avoided, thus achieving a uniform final cut of the processed food.

Optionally, the cutting sectors (3c) of the additional unitary cutting accessory (3) may be delimited by bending the cutting sector blades (3c.1) (see FIG. 3C).

With this configuration, in addition to achieving the delimitation of cutting sectors (3c) composed of similarly oriented cutting sector blades (3c.1), the number of fastening elements holding the cutting sector blades (3c.1) in place may also be reduced, facilitating the cleaning and manufacturing of the additional unitary cutting accessory (3).

The food processing machine (1) may include a guide disc (4) (FIG. 1) connected to the connection shaft (1a), located immediately after the additional unitary cutting accessory (3). The guide disc (4) may have a central guide ring (4a) formed by at least one smooth wall. The guide disc (4) may rotate by the push of the thrust wall (1a.3) of the connection shaft (1a) against the at least one smooth wall forming the central guide ring (4a) of the guide disc (4). The guide disc (4) may also include at least one guide fin (4b) configured, in its rotational movement, to collect the processed food that falls by gravity and by the push of other processed food following it from the additional unitary cutting accessory (3) and guide it to the outlet ramp (1b). The processed food maybe then be evacuated thanks to the slope of the outlet ramp (1b) (see FIG. 4), which is steeper in its final section.

Thanks to this guide disc (4), soft foods such as tomatoes can be gently collected and immediately directed to the outlet ramp (1b), preventing the freshly processed food from falling on top of previously processed food. By promptly and gently evacuating freshly processed food, damage caused by impact or accumulation at the initial section (with a gentle slope) of the outlet ramp (1b) may be avoided.

Variations in materials, shape, size, and arrangement of the component elements described in a non-limiting manner do not alter the essence of this inventive subject matter herein, and the description is sufficient for reproduction of examples of the inventive subject matter by a person skilled in the art.

What is claimed is:

1. A food processing machine adapted for diced cuts, comprising:
a feed chute configured to receive and direct a food substrate for processing; and
a strip-cutting disc operatively connected to a connection shaft configured to transmit rotation from a motor,
wherein the strip-cutting disc comprises at least one H-blade configured to make a cut perpendicular to a direction of the feed chute, and a plurality of V-blades, wherein the V-blades are configured to make a cut in a direction of rotation of the strip-cutting disc, and
wherein the strip-cutting disc further comprises an output ramp for discharging the processed food, characterized in that the output ramp comprises an additional unitary cutting accessory configured in cutting sectors, connected to the connection shaft and following the strip-cutting disc, and configured to make a cut substantially parallel to the connection shaft in at least portions thereof.

2. The food processing machine of claim 1, characterized in that the additional unitary cutting accessory is configured in at least two cutting sectors comprising blades and arranged in a radial distribution.

3. The food processing machine of claim 2, characterized in that the additional unitary cutting accessory may include an additional blade at a junction between cutting sectors.

4. The food processing machine of claim 2, characterized in that the cutting sectors of the additional unitary cutting accessory may be delimited by bending of the cutting sector blades.

5. The food processing machine of claim 1, further comprising a guide disc connected to the connection shaft following the additional unitary cutting accessory, wherein the guide disc comprises at least one guide fin capable of collecting the processed food and directing it to the output ramp.

6. The food processing machine of claim 1, characterized in that the additional unitary cutting accessory includes at least one lug capable of fitting into at least one corresponding engagement recess in the food processing machine.

7. The food processing machine of claim 1, wherein at least some of the V-blades are substantially parallel with each other.

8. The food processing machine of claim 1, wherein at least some of the V-blades are substantially perpendicular to the at least one H-blade.

9. The food processing machine of claim 1, wherein the additional unitary cutting accessory is connected to the connection shaft following the strip-cutting disc.

10. The food processing machine of claim 1, wherein the additional unitary cutting accessory is connected to the connection shaft immediately following the strip-cutting disc.
